(19) United States
(12) Patent Application Publication
(10) Pub. No.: US 2014/0166713 A1
(43) Pub. Date: Jun. 19, 2014

(54) CARGO CARRIER SYSTEM FOR VEHICLE

(71) Applicant: Ralph Preston Kirtland, Staunton, VA (US)

(72) Inventor: Ralph Preston Kirtland, Staunton, VA (US)

(21) Appl. No.: 14/187,238

(22) Filed: Feb. 22, 2014

(51) Int. Cl. B60R 9/06

(52) U.S. Cl. CPC B60R 9/06
USPC 224/521

(57) ABSTRACT

An improved modular cargo carrying system for safely and securely transporting external cargo with a vehicle. A unique mounting arrangement removably attaches one or more cargo carrier elements to a bumper or external frame member of a vehicle, distributing the cargo weight over a broad area of the bumper or frame member. Multiple cargo carrier elements can be removably attached to each other to form a larger, contiguous cargo carrier structure. Supplemental sides can be removably attached around the perimeter of one or more cargo carrier elements to better restrain cargo. Supplemental support structures can be added to the vehicle in contact with and constraining the bumper or frame member to augment the load carrying capacity and reduce the possibility of fatigue induced bumper or frame member failure.

### FIELD OF THE INVENTION

This invention is related to a cargo carrier system for vehicles that increases the cargo carrying capacity by removably attaching a cargo support structure to a bumper or frame member and optionally reinforcing said bumper or frame member with a support structure that constrains said bumper or frame member.

### BACKGROUND OF THE INVENTION

The recreational vehicle (RV) business is currently booming, setting record sales numbers since 2010, rebounding considerably from the lull brought about by the recession of 2008. There exists today an insufficiently-satisfied—unmet—need in the RV industry for efficient external transport of “dirty” cargo such as generators, gas cans, propane tanks, grills, etc. One cannot travel very far without seeing all manner of cargo strapped haphazardly to the back of RVs; this creates safety and financial risks from the potential unexpected loss of cargo as well aesthetic issues from the cargo's unkempt appearance.

Wikipedia (http://en.wikipedia.org/wiki/Recreational_vehicle) defines a recreational vehicle, or RV, in North America as “the usual term for a motor vehicle or trailer equipped with living space and amenities found in a home . . . In the US, the modern RV industry had its beginnings in the late 1920s and 1930s (shortly after the advent of the automobile industry), where a number of companies began manufacturing house trailers or trailer coaches, as they were then called. Often, these started out as mom and pop operations, building their units in garages or back yards. (One of these early manufacturers, Airstream, is still in business today.) Though tied to the mobile home industry in the early years—when few units were longer than 9 metres (30 ft) long, and thus easily transportable—the 1950s saw a separation of the two, as (what are now referred to as) mobile homes became larger and more immobile, and thus largely became an entirely separate industry. During the 1950s, in addition to travel trailers or trailer coaches, manufacturers began building self-contained motorhomes.”

In the almost 100 years of North American RV production, the art of external cargo transport has stagnated on the combination of a receiver hitch mounted cargo carrier, as exemplified in U.S. Pat. No. 7,316,339, and a bumper mounted receiver hitch, as exemplified in U.S. Pat. No. 6,474,522. Notable shortcomings of this solution include a) the additional cost to the consumer resulting from the manufacture of these two distinct parts, b) the additional weight of the cargo carrier resulting from reinforcement needed to support the weight being borne by the central bar that interfaces with the receiver hitch, c) the shake, rattle, and roll (tilt) created by the loose fit of the cargo carrier within the receiver hitch, and d) the additional stress loads from said combination focused on a very narrow area of the traditionally thin-walled RV bumper due to the small size of said bumper mounted receiver hitch in relation to the bumper.

In addition to the risk of permanent bumper twist and cyclical bouncing during travel resulting from the torsional load generated on the bumper by the cargo carrier and receiver hitch combination described above, there is the all-too-often occurrence of complete bumper failure, as shown in the image at http://i45.tinypic.com/wmc682.jpg. The ubiquitous 4-inch square steel bumper (example: http://www.rvsurplus.net/catalog/display.php?product_id=1474) is typically attached to the RV in one of two ways: It is either welded directly to the frame or it is bolted to flanges which are welded to the frame. In the former attachment means, failure occurs when the bumper's wall surrounding the weld tears away; in the latter attachment means, failure occurs when the cyclical tensional loads on the fasteners cause them to break along a tightening thread due to fatigue.

Two attempts by the industry at providing improved external cargo transport involved permanently attached cargo carriers that would either fold up when not in use (example: http://cdn.forestriverforums.com/forums/attachment.php?attachmentid=23087&d=1358453834) or slide back into a cavity in the vehicle's frame (example: http://asurvivalplan.com/wp-content/uploads/2012/02/RearCargoTray.png). The market's response to these solutions has been muted due most likely to the need to have these solutions installed at the frame factory as well as the extra weight these solutions added to the rear of the RV; tow-behind RVs (travel trailers) are especially sensitive to fore and aft balancing, the trailer wheels being the fulcrum, and excessive weight added to the rear can significantly destabilize the towing and towed vehicle combination during travel, increasing the risk of an accident.

The present invention satisfies the current need for an improved cargo carrier system for vehicles in that it a) utilizes existing vehicle components for direct, removable attachment, b) allows for the reinforcement of said vehicle components, c) allows for the distribution of load over a greater area of said vehicle components, d) allows for a lighter cargo carrier relative to strength through integration with said vehicle components, e) meets a wide variety of cargo transport needs as it is modular and configurable, f) eliminates the shake, rattle, and roll of the current art, and g) can be installed either at the factory or by the user, allowing a buyer to defer their cargo carrier decision until needed.

### SUMMARY OF THE INVENTION

The present invention provides a cargo support structure for use in cooperation with a vehicle, whereby said cargo support structure is comprised of one or more cargo carrier elements removably attached at one end to a vehicle component such as a bumper or other externally exposed frame member.

The invention may include individual said cargo carrier elements comprised of a horizontal surface for cargo support and vertical sides to support said horizontal surface, thereby creating a cargo support platform.

The invention may integrate said vehicle component as a structural member of individual said cargo carrier elements, thereby reducing the amount of material needed to create individual said cargo carrier elements, thereby reducing the weight and cost of individual said cargo carrier elements.

The invention may provide a means for mounting said cargo carrier elements side-by-side, in a contiguous configuration, thereby creating a larger or more customized cargo support structure.

The invention may provide a means for removably attaching cargo carrier side elements around the perimeter of individual said cargo carrier elements or a plurality of said cargo carrier elements in said contiguous configuration to assist in the restraint of cargo.

The invention may include individual said cargo carrier elements wherein opposing sides are sufficient in length and opposition to overlay opposing sides of said vehicle component and may further include one or more clamping members to draw the opposing sides of each said cargo carrier elements closer, creating a clamping force on said vehicle component for the purpose of removably attaching individual said cargo carrier elements to said vehicle component. The invention may use standard threaded fasteners such as nuts and bolts in combination with said opposing sides as said clamping mechanism.

The invention may include individual said cargo carrier elements which provide cargo support when attached to said vehicle component in alternate vertically opposed orientations, allowing the user to choose between carrying cargo in a low mounted orientation supported in tension by individual said cargo carrier elements or in a high mounted orientation supported in compression by individual said cargo carrier elements.

The invention may include individual said cargo carrier elements which can be alternately attached to said vehicle component in a horizontally disposed orientation useful for the transport of cargo and a vertically disposed orientation useful for transporting individual said cargo carrier elements in a less obtrusive manner when not in use carrying cargo.

The invention may provide a support structure element that constrains the vehicle component to which said cargo carrier element is attached in order to strengthen said vehicle component.

### BRIEF DESCRIPTION OF THE DRAWINGS

The invention will be better understood with reference to the attached drawings, in which:

FIG. 1 is a top perspective view of a typical travel trailer variant of a recreational vehicle with a cargo carrier element removably attached in a horizontally disposed low mounted orientation;

FIG. 2 is a top perspective view of a typical travel trailer variant of a recreational vehicle with a cargo carrier element removably attached in a vertically disposed orientation for stowage;

FIG. 3 is a top perspective view of a typical travel trailer variant of a recreational vehicle with a cargo carrier element removably attached in a horizontally disposed high mounted orientation and removably attached support structure elements;

FIG. 4 is an exploded top perspective view of the bumper and frame members of a typical travel trailer variant of a recreational vehicle with a cargo carrier element positioned to be removably attached in a horizontally disposed high mounted orientation;

FIG. 5 is a bottom perspective view of the bumper and frame members of a typical travel trailer variant of a recreational vehicle with a cargo carrier element removably attached in a horizontally disposed high mounted orientation;

FIG. 6 is a top perspective view of the bumper and frame members of a typical travel trailer variant of a recreational vehicle with a cargo carrier element removably attached in a horizontally disposed high mounted orientation;

FIG. 7 is an exploded bottom perspective view of a removably attached support structure element in relation to the bumper and frame members of a typical travel trailer variant of a recreational vehicle;

FIG. 8 is a transparent bottom perspective view of a removably attached support structure element in relation to the bumper and frame members of a typical travel trailer variant of a recreational vehicle;

FIG. 9 is a bottom perspective view of a permanently attached support structure element in relation to the bumper and frame members of a typical travel trailer variant of a recreational vehicle;

FIG. 10 is a transparent bottom perspective view of a permanently attached support structure element in relation to the bumper and frame members of a typical travel trailer variant of a recreational vehicle;

FIG. 11 is a top perspective view of a permanently attached support structure element in relation to the bumper and frame members of a typical travel trailer variant of a recreational vehicle;

FIG. 12 is a top perspective view of a permanently attached support structure element in relation to the bumper and frame members of a typical travel trailer variant of a recreational vehicle with a cargo carrier element removably attached in a horizontally disposed low mounted orientation;

FIG. 13 is a top perspective view of a permanently attached support structure element in relation to the bumper and frame members of a typical travel trailer variant of a recreational vehicle with a cargo carrier element removably attached in a horizontally disposed high mounted orientation;

FIG. 14 is an exploded top perspective view of a cargo carrier element in a horizontally disposed high mounted orientation with two cargo carrier side elements removably attached around the perimeter and two cargo carrier side elements in position to be attached;

FIG. 15 is a bottom perspective view of a cargo carrier element in a horizontally disposed high mounted orientation with cargo carrier side elements removably attached around the perimeter;

FIG. 16 is a top perspective view of permanently attached support structure elements in relation to the bumper and frame members of a typical travel trailer variant of a recreational vehicle with a cargo carrier element removably attached in a horizontally disposed high mounted orientation with cargo carrier side elements removably attached around the perimeter;

FIG. 17 is a bottom perspective view of permanently attached support structure elements in relation to the bumper and frame members of a typical travel trailer variant of a recreational vehicle with two contiguous cargo carrier elements removably attached in a horizontally disposed high mounted orientation;

FIG. 18 is a top perspective view of permanently attached support structure elements in relation to the bumper and frame members of a typical travel trailer variant of a recreational vehicle with two contiguous cargo carrier elements removably attached in a horizontally disposed high mounted orientation with cargo carrier side elements removably attached around the perimeter;

FIG. 19 is a bottom perspective view of the bumper and frame members of a typical travel trailer variant of a recreational vehicle with three contiguous cargo carrier elements removably attached in a horizontally disposed high mounted orientation;

FIG. 20 is a top perspective view of the bumper and frame members of a typical travel trailer variant of a recreational vehicle with three contiguous cargo carrier elements removably attached in a horizontally disposed high mounted orientation with cargo carrier side elements removably attached around the perimeter;

### DETAILED DESCRIPTION OF THE PREFERRED EMBODIMENT(S)

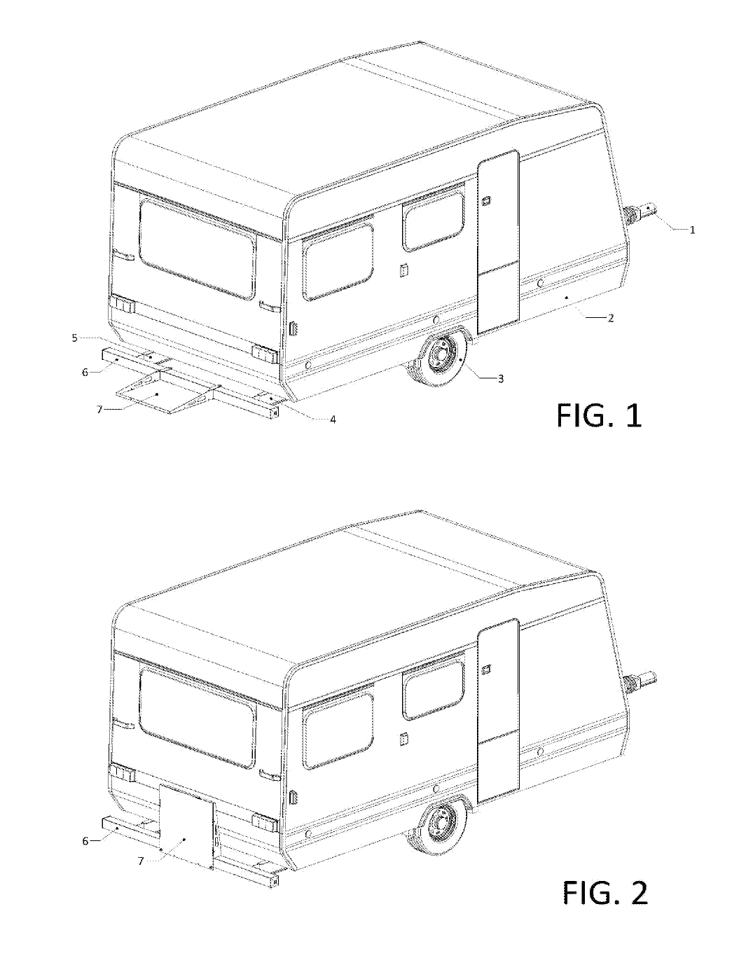

FIG. 1 shows a typical travel trailer variant of a recreational vehicle comprising a hitch coupler 1, a weatherproof shell 2 for the living quarters, wheels 3 to allow for travel, a pair of frame rails identified as the starboard frame member 4 and port frame member 5 to support shell 2 above wheels 3, and a bumper 6 attached to frame members 4 and 5. A cargo carrier element 7 of the invention is removably attached to bumper 6 in a horizontally disposed low mounted orientation.

FIG. 2 shows a typical travel trailer variant of a recreational vehicle with cargo carrier element 7 of the invention removably attached to bumper 6 in a vertically disposed orientation.

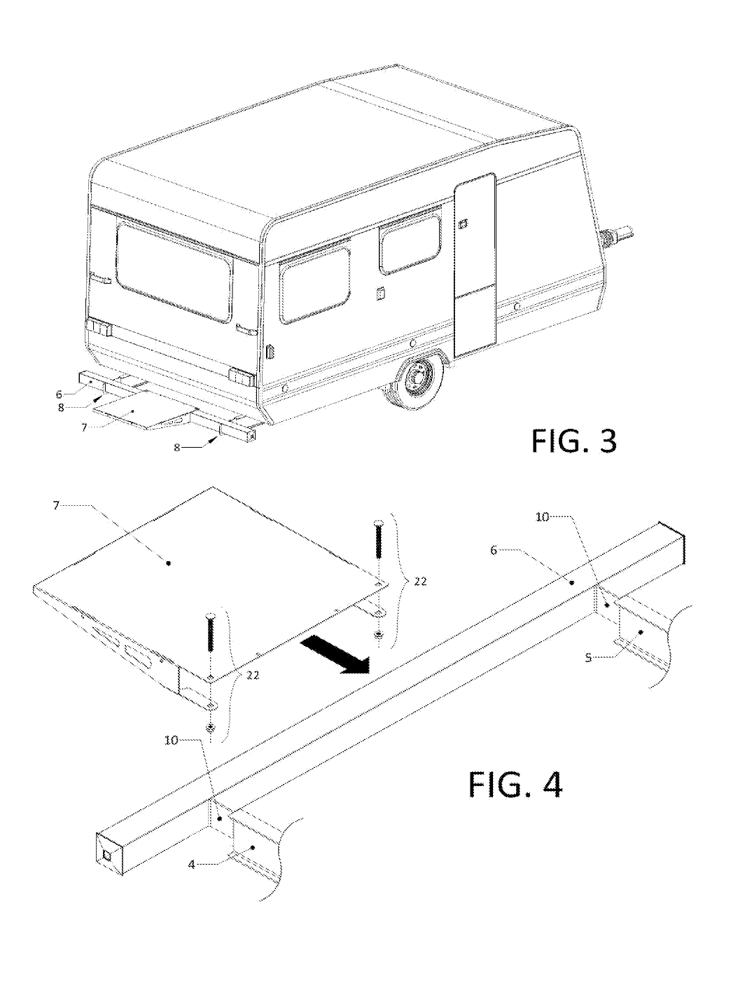

FIG. 3 shows a typical travel trailer variant of a recreational vehicle with removably attached support structure elements 8 and cargo carrier element 7 of the invention removably attached to bumper 6 in a horizontally disposed high mounted orientation.

FIG. 4 shows bumper 6, starboard frame member 4, port frame member 5, and frame extenders 10 of a typical travel trailer variant of a recreational vehicle with cargo carrier element 7 in a horizontally disposed high mounted orientation in position to be removably attached to bumper 6 via the clamping force generated by fasteners 22.

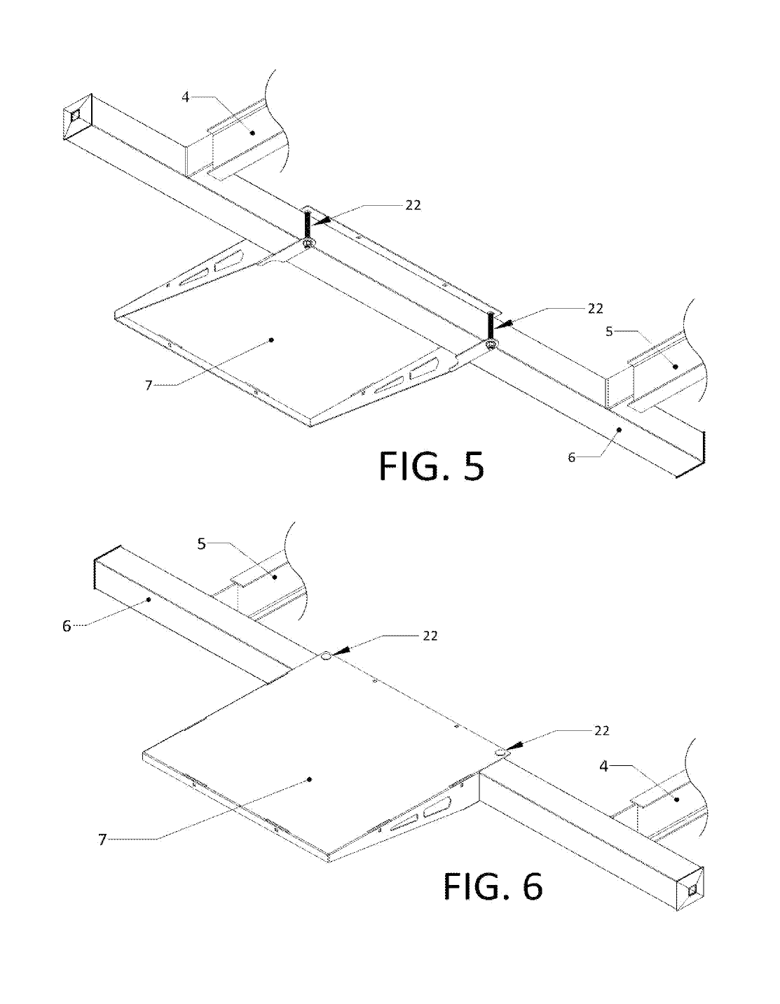

FIG. 5 shows the underside of bumper 6, starboard frame member 4, port frame member 5, and frame extender 10 of a typical travel trailer variant of a recreational vehicle with cargo carrier element 7 in a horizontally disposed high mounted orientation removably attached to bumper 6 via the clamping force generated by fasteners 22.

FIG. 6 shows bumper 6, starboard frame member 4, and port frame member 5 of a typical travel trailer variant of a recreational vehicle with cargo carrier element 7 removably attached to bumper 6 in a horizontally disposed high mounted orientation via the clamping force generated by fasteners 22.

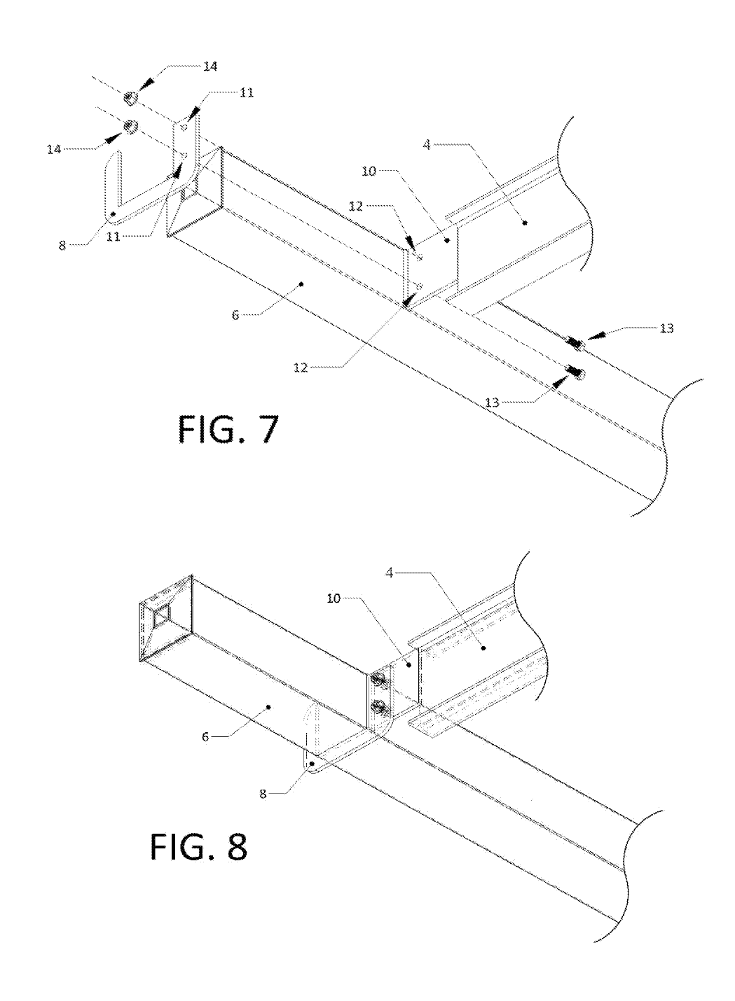

FIG. 7 shows the underside of bumper 6, starboard frame member 4, and frame extender 10 of a typical travel trailer variant of a recreational vehicle with holes 12 introduced into frame extender 10 to align with holes 11 in support structure element 8 to receive bolts 13 in combination with nuts 14 to removably attach support structure element 8 to frame extender 10.

FIG. 8 transparently shows the underside of bumper 6, starboard frame member 4, and frame extender 10 of a typical travel trailer variant of a recreational vehicle wherein bumper 6 is constrained by support structure element 8 while it is removably attached to frame extender 10.

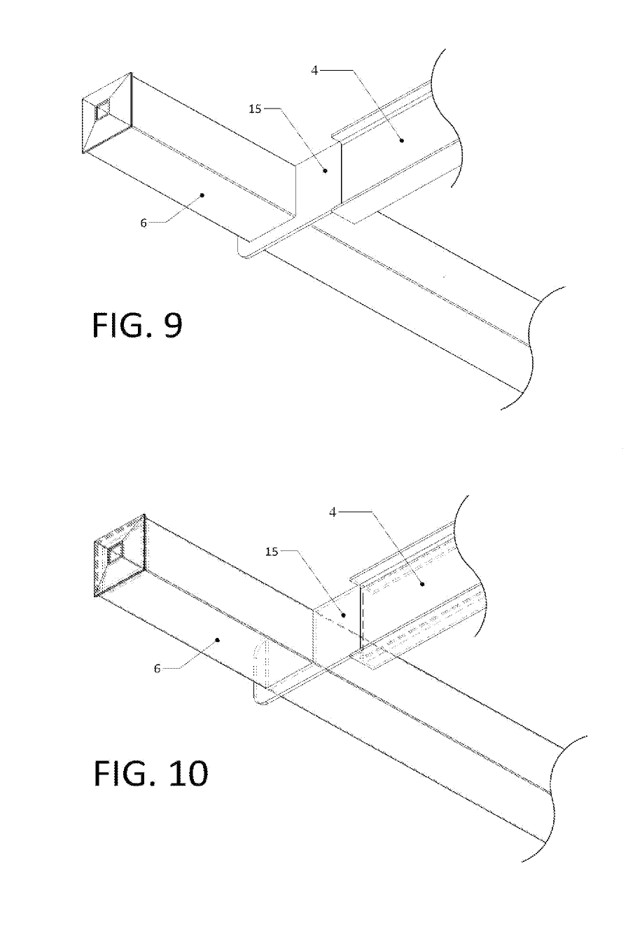

FIG. 9 shows the underside of bumper 6, starboard frame member 4, and a support structure element variant 15 wherein support structure element variant 15 is permanently attached to bumper 6 and starboard frame member 4, replacing frame extender 10 and support structure element 8 shown in FIG. 8.

FIG. 10 transparently shows the underside of bumper 6, starboard frame member 4, and support structure element variant 15 wherein support structure element variant 15 is permanently attached to bumper 6 and starboard frame member 4, replacing frame extender 10 and support structure element 8 shown in FIG. 8.

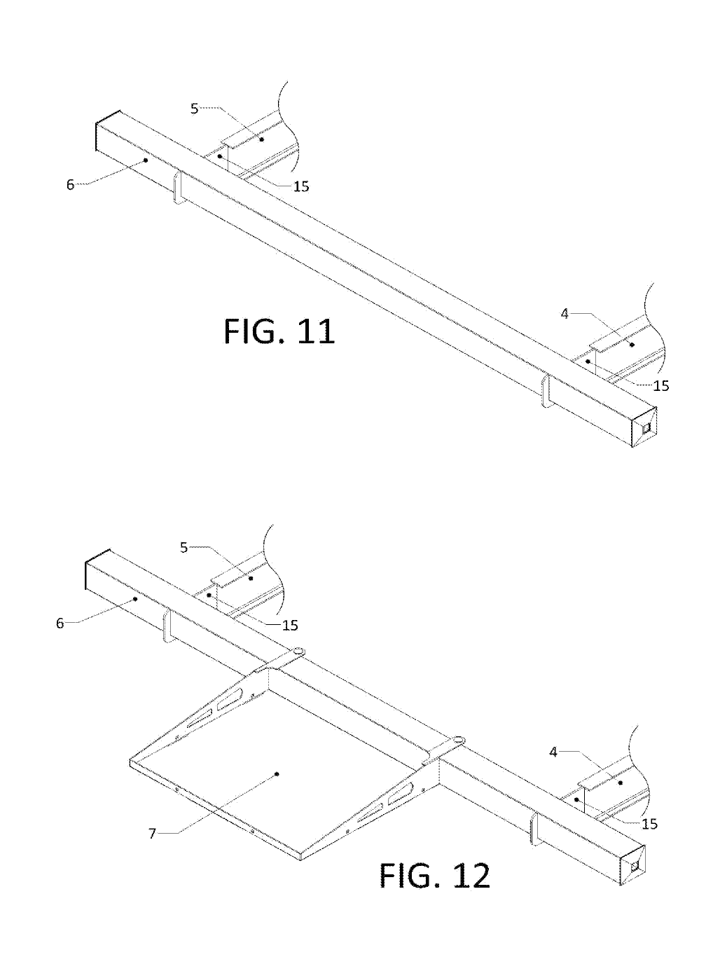

FIG. 11 shows bumper 6, starboard frame member 4, port frame member 5, and support structure element variant 15 wherein support structure element variants 15 are permanently attached to bumper 6 and frame member 4 and 5.

FIG. 12 shows bumper 6, starboard frame member 4, port frame member 5, and two support structure element variants 15 wherein cargo carrier element 7 is removably attached to bumper 6 in a horizontally disposed low mounted orientation.

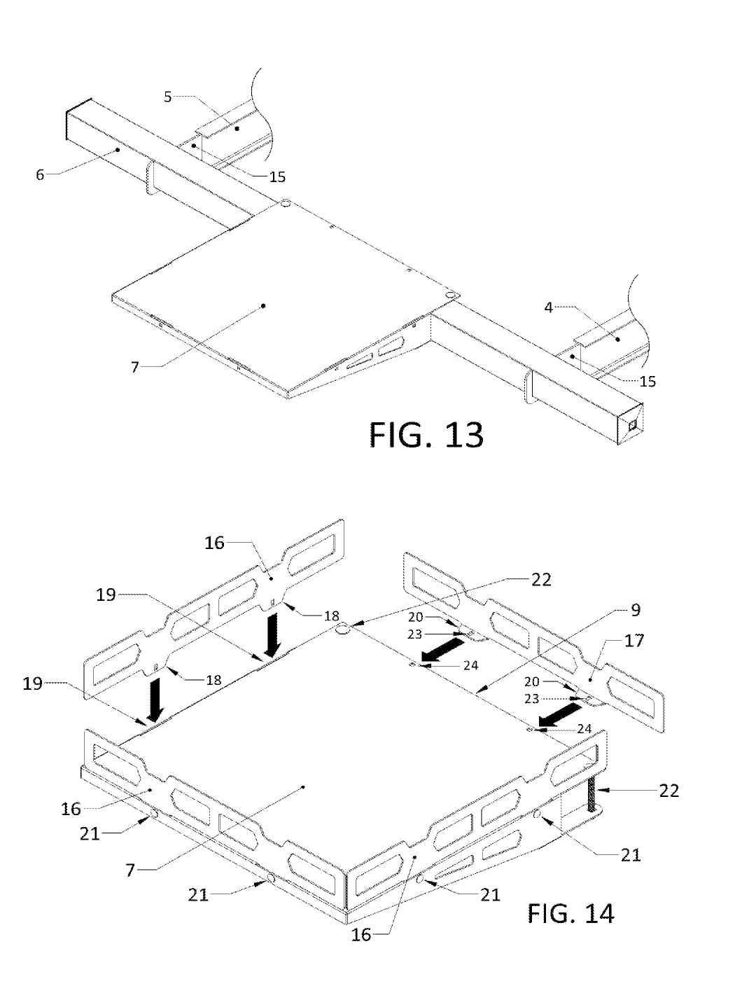

FIG. 13 shows bumper 6, starboard frame member 4, port frame member 5, and two support structure element variants 15 wherein cargo carrier element 7 of the invention is removably attached to bumper 6 in a horizontally disposed high mounted orientation.

FIG. 14 shows cargo carrier element 7 in a horizontally disposed high mounted orientation with clamping fasteners 22 inserted and with two cargo carrier side elements 16 removably attached to two sides of the perimeter via fasteners 21, a third cargo carrier side element 16 in position to have its tabs 18 inserted into slots 19 and cargo carrier side element variation 17 in position to have its tabs 20 positioned against horizontal surface 9 so that holes 23 align with holes 24.

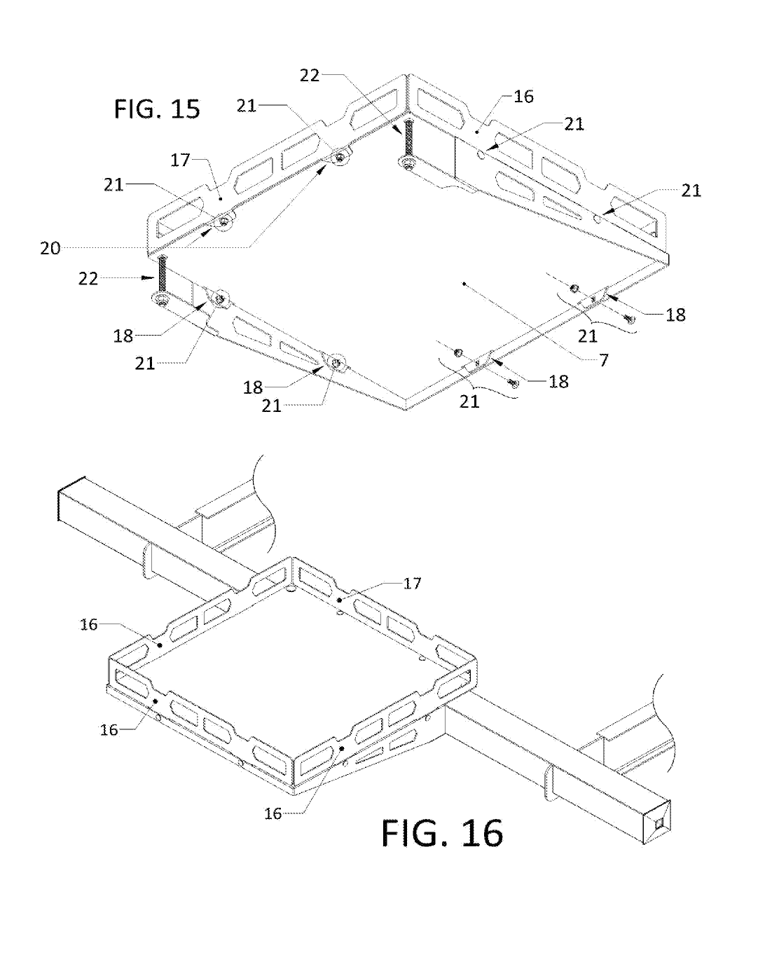

FIG. 15 shows the underside of cargo carrier element 7 of the invention in a horizontally disposed high mounted orientation with clamping fasteners 22 inserted and three cargo carrier side elements 16 removably attached to three sides of the perimeter with their tabs 18 secured via fasteners 21 and cargo carrier side element variation 17 removably attached with its tabs 20 secured via fasteners 21.

FIG. 16 shows three cargo carrier side elements 16 and one cargo carrier side element variation 17 removably attached around the perimeter of a cargo carrier element in a horizontally disposed high mounted orientation.

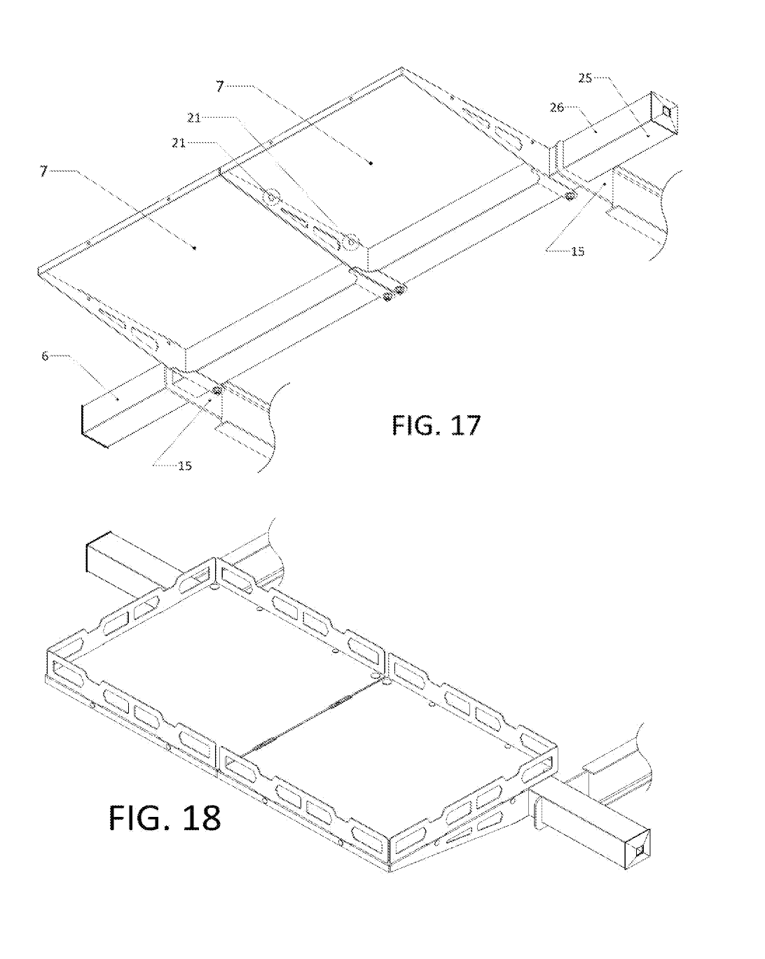

FIG. 17 shows the underside of two contiguous cargo carrier elements 7 removably attached in a horizontally disposed high mounted orientation to bumper 6 via clamping fasteners and to each other via fasteners 21 with support structure element variants 15 constraining bumper 6 by contacting the horizontally disposed underside 25 and outermost vertically disposed side 26 of bumper 6.

FIG. 18 shows the topside of the two contiguous cargo carrier elements of FIG. 17 with the addition of four cargo carrier side elements and two cargo carrier side element variants removably attached around the perimeter.

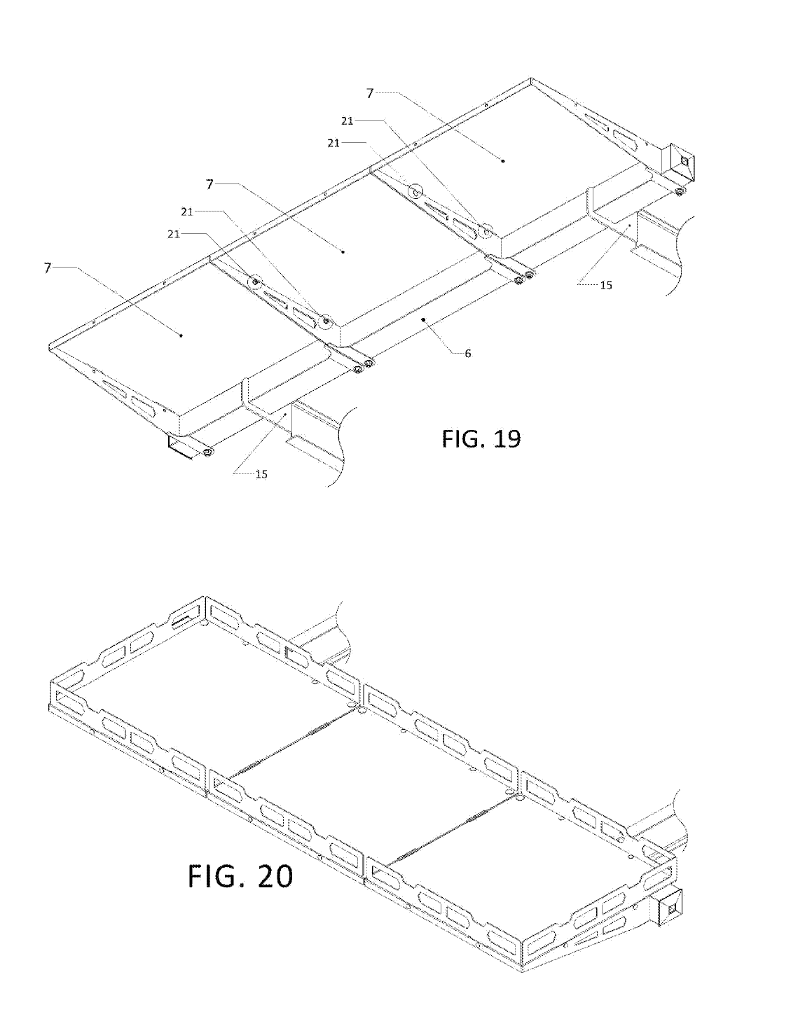

FIG. 19 shows the underside of three contiguous cargo carrier elements 7 removably attached in a horizontally disposed high mounted orientation to bumper 6 via clamping fasteners and to each other via fasteners 21. Support structure element variants 15 are shown constraining bumper 6 without interfering in the attaching of the cargo carrier elements 7.

FIG. 20 shows the topside of the three contiguous cargo carrier elements of FIG. 19 with the addition of five cargo carrier side elements and three cargo carrier side element variants removably attached around the perimeter.

I claim:

1. A cargo support structure for use in cooperation with a vehicle, comprising one or more cargo carrier elements having an indeterminate width, length, and height removably attached at one end to said vehicle along a rearmost or foremost laterally disposed frame member or a sidemost longitudinally disposed frame member or a bumper.

2. The cargo support structure of claim 1, wherein a plurality of said cargo carrier elements are contiguous.

3. The cargo support structure of claim 1, wherein a plurality of said cargo carrier elements are contiguous and provide a means for removably attaching sides around the perimeter.

4. The cargo support structure of claim 1, wherein individual said cargo carrier elements comprise a horizontal surface and vertical sides.

5. The cargo support structure of claim 1, wherein individual said cargo carrier elements comprise a horizontal surface and a means for removably attaching vertical sides.

6. The cargo support structure of claim 1, wherein opposing sides of individual said cargo carrier elements are sufficient in length and opposition to overlay opposing sides of the frame member or said bumper.

7. The cargo support structure of claim 1, wherein opposing sides of individual said cargo carrier elements are sufficient in length and opposition to overlay opposing sides of the frame member or said bumper and incorporate one or more clamping members to draw the opposing sides of each said cargo carrier elements closer.

8. The cargo support structure of claim 1, wherein individual said cargo carrier elements can support cargo when alternately attached to the frame member or said bumper in vertically opposed orientations.

9. The cargo support structure of claim 1, wherein individual said cargo carrier elements can be alternately attached to the frame member or said bumper in a horizontally disposed orientation and a vertically disposed orientation.

10. The cargo support structure of claim 1, wherein the frame member or said bumper is an integrated member of individual said cargo carrier elements.

11. The cargo support structure of claim 1, wherein the frame member or said bumper is constrained by a support structure which contacts the horizontally disposed underside and vertically disposed side outermost from the center of said vehicle of the frame member or said bumper with said support structure attached to the frame of said vehicle.

12. A cargo support structure for use in cooperation with a vehicle, comprising:
(a) one or more cargo carrier elements each having an indeterminate width, length, and height and removably attached at one end to said vehicle along a rearmost or foremost laterally disposed frame member or a sidemost longitudinally disposed frame member or a bumper;
(b) said cargo carrier elements each comprising a horizontal surface and vertical sides and a means for removably attaching additional vertical sides;
(c) said cargo carrier elements each possessing opposing sides sufficient in length and opposition to overlay opposing sides of the frame member or said bumper and incorporating one or more clamping members to draw the opposing sides of each said cargo carrier elements closer.

13. The cargo support structure of claim 12, wherein individual said cargo carrier elements can support cargo when alternately attached to the frame member or said bumper in vertically opposed orientations.

14. The cargo support structure of claim 12, wherein a plurality of said cargo carrier elements are contiguous.

15. The cargo support structure of claim 12, wherein a plurality of said cargo carrier elements are contiguous and provide a means for removably attaching sides around the perimeter.

16. The cargo support structure of claim 12, wherein individual said cargo carrier elements can be alternately attached to the frame member or said bumper in a horizontally disposed orientation and a vertically disposed orientation.

17. The cargo support structure of claim 12, wherein the frame member or said bumper is an integrated member of individual said cargo carrier elements.

18. The cargo support structure of claim 12, wherein the frame member or said bumper is constrained by a support structure which contacts the horizontally disposed underside and vertically disposed side outermost from the center of said vehicle of the frame member or said bumper with said support structure attached to the frame of said vehicle.

19. A cargo support structure for use in cooperation with a vehicle, comprising:
(a) one or more cargo carrier elements each having an indeterminate width, length, and height and removably attached at one end to said vehicle along a rearmost or foremost laterally disposed frame member or a sidemost longitudinally disposed frame member or a bumper;
(b) said cargo carrier elements each comprising a horizontal surface and vertical sides and a means for removably attaching additional vertical sides;
(c) said cargo carrier elements each possessing opposing sides sufficient in length and opposition to overlay opposing sides of the frame member or said bumper and incorporating one or more clamping members to draw the opposing sides of each said cargo carrier elements closer;
(d) one or more support structures which constrain the frame member or said bumper and contact the horizontally disposed underside and vertically disposed side outermost from the center of said vehicle of the frame member or said bumper with said support structure attached to the frame of said vehicle.

20. The cargo support structure of claim 19, wherein a plurality of said cargo carrier elements are contiguous.
